(19) United States
(12) Patent Application Publication
(10) Pub. No.: US 2007/0204648 A1
(43) Pub. Date: Sep. 6, 2007

(54) Step-down top hinge for refrigerator door with external dispenser

(76) Inventors: Jeffrey J. Smale, Newburgh, IN (US); Mark G. Steffenhagen, Evansville, IN (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/367,833

(22) Filed: Mar. 3, 2006

(51) Int. Cl. B67D 5/62; F25D 11/00

(52) U.S. Cl. 62/389; 62/440

(57) ABSTRACT

A top hinge for a refrigerator door is provided with a first area having an upper surface and having a lower surface, a second area having an upper surface and a lower surface, both surfaces being laterally displaced from the first area lower surface. A hollow pintle extends in a first direction from the lower surface of the second area. The upper surface of the second area is displaced in the first direction from the upper surface of the first area, and a transition section connects the first area and the second area.

### BACKGROUND OF THE INVENTION

The present invention relates generally to hinges for refrigerators and in particular to hinges for refrigerators having water dispensers in the door of the refrigerator.

Refrigerators having water dispensers in the door are well known, as are arrangements for permitting the reversibility of the door swing of the refrigerator having a water dispenser in the door. For example, U.S. Pat. No. 6,868,692 discloses a refrigerator with an in-door water dispenser in which the water is supplied through a top hinge connection with the refrigerator cabinet. Typically, the hinge may be completely flat, or may have a step in it, such that the portion of the hinge positioned over the refrigerator door is stepped up, or is at a higher elevation than the portion of the hinge that is attached to the refrigerator cabinet. This arrangement is seen in FIG. 2 of the '692 patent, and is similar to the shape of the hinge disclosed in U.S. Pa. No. ______. When a flat or stepped-up top hinge is employed in a refrigerator with an in-door water dispenser, the water tube exiting the top of the hinge extends a significant distance above the top surface of the refrigerator cabinet, and must be bent through a large radius bend to allow the water tube to reenter the refrigerator cabinet. Usually a cover is provided over the hinge and tube to protect the tube and enhance the aesthetic appearance of the refrigerator, and when the hinge is flat or stepped up, the cover extends a significant distance above the top of the refrigerator cabinet.

The use of a hollow pintle in a hinge, for passage of water lines and electric lines is disclosed, for example, in U.S. Pat. No. 4,543,800.

A “step-down” hinge construction, using a solid pintle, and a special mounting bracket arrangement extending a significant distance above the top of the refrigerator cabinet, is shown in U.S. Pat. No. 5,960,518.

It would be an improvement in the art if a hinge were provided for a refrigerator with an in-door water dispenser that would allow for a lower profile for the hinge and water tube, as well as for a cover for the hinge.

### SUMMARY OF THE INVENTION

The present invention provides a hinge for a refrigerator with an in-door water dispenser. In an embodiment, a refrigerator having an in-door water dispenser and a water routing system is provided with a cabinet enclosing a refrigeration compartment. A door closes a front opening into the refrigeration compartment. The door is arranged to be hinged at a first edge to the cabinet along a first edge of a front of the cabinet and alternatively at a second edge to the cabinet along a second edge of a front of the cabinet. A water dispenser is mounted on the door and is accessible from an exterior of the cabinet. A water supply line leads from a reservoir in the cabinet to an end adjacent to a first top front corner of the cabinet at the first cabinet edge. A feeder line leads from the dispenser to an end adjacent a top surface of the door at the first door edge. A top hinge for the refrigerator door includes a hollow pintle through which the feeder line extends. The hinge comprises a first area configured to be received on a top surface of the refrigerator cabinet, a second area, substantially parallel to and positioned at a lower altitude than the first area, the second area carrying the pintle such that an axis of rotation through the pintle is substantially perpendicular to a surface of the second area, and a transition section connecting the first area and the second area.

In an embodiment, the transition section is a solid web extending between the first area and the second area.

In an embodiment, the transition section joins the first area at a first bend in the hinge and the transition section joins the second area at a second bend in the hinge.

In an embodiment, the first and second bends are each less than 90 degrees.

In an embodiment, the first and second areas are substantially planar.

In an embodiment, a refrigerator having an in-door water dispenser is supplied with water through a conduit leading from a reservoir in a cabinet of the refrigerator and a top hinge for a door of the refrigerator. The hinge includes a first area configured to be received on a top surface of the refrigerator cabinet, a hollow pintle through which the conduit extends, and a second area, substantially parallel to and positioned at a lower altitude than the first area. The second area carries the pintle such that an axis of rotation through the pintle is substantially perpendicular to the top surface of the refrigerator cabinet. A transition section connects the first planar area and the second planar area.

In an embodiment, a top hinge is provided for a refrigerator door. The hinge includes a first area having an upper surface and having a lower surface, a second area, with an upper surface and a lower surface, both surfaces being laterally displaced from the first area lower surface, a hollow pintle extending in a first direction from the lower surface of the second area, the upper surface of the second area being displaced in the first direction from the upper surface of the first area, and a transition section connecting the first area and the second area.

In an embodiment, the first area is substantially planar.

In an embodiment, the second area is substantially planar.

In an embodiment, the upper and lower surfaces of the first and second areas are each substantially parallel to each other.

In an embodiment, the first area includes fastener openings therein.

In an embodiment, the transition section is a solid web extending between the first area and the second area.

In an embodiment, the transition section joins the first area at a first bend in the hinge and the transition section joins the second area at a second bend in the hinge.

In an embodiment, the first and second bends are each less than 90 degrees.

In an embodiment, the pintle extends substantially perpendicularly from the lower surface of the second area.

These and other aspects and details of the present invention will become apparent upon a reading of the detailed description and a review of the accompanying drawings. Specific embodiments of the present invention are described herein. The present invention is not intended to be limited to only these embodiments. Changes and modifications can be made to the described embodiments and yet fall within the scope of the present invention.

### BRIEF DESCRIPTION OF THE DRAWINGS

FIG. 1 is a partial perspective view of a refrigerator embodying the principles of the present invention.

FIG. 2 is a schematic view of the refrigerator door and cabinet showing a water line routing with a first swing of the door.

FIG. 3 is a schematic view of the refrigerator door and cabinet showing a water line routing with an opposite swing of the door from that shown in FIG. 2.

FIG. 4 is a top partial perspective view of a refrigerator with an alternate water line routing.

FIG. 5 is a schematic view of the door of the refrigerator with a feed line routing.

FIG. 6 is a perspective view of a hinge area at the top of the refrigerator cabinet.

FIG. 7 is a side sectional view of the hinge area, and protective cover, generally in the region of FIG. 6.

### DETAILED DESCRIPTION OF THE PREFERRED EMBODIMENTS

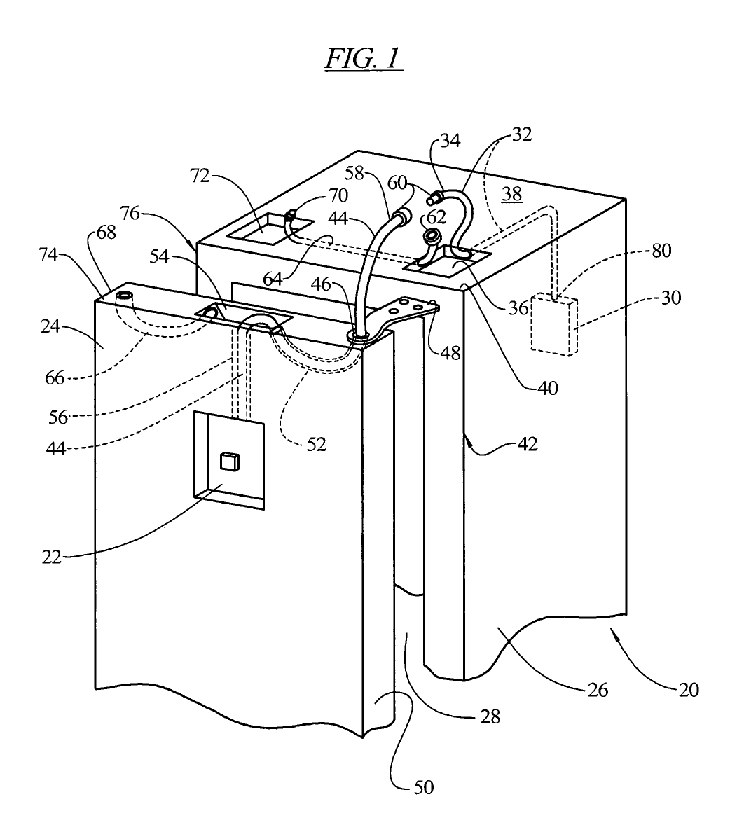

In an embodiment, as illustrated in FIG. 1, the present invention provides a refrigerator 20 with an in-door water dispenser 22 in which a swing of a door 24 may be readily reversed or changed, from left to right and back, while allowing for easy transfer of a water supply routing and connection and a hinge from one side of the door to the other side of the door.

In an embodiment, the refrigerator 20 comprises a cabinet 26 enclosing a refrigeration compartment 28, with a water routing system including a first water supply line connection 30 at a first top front corner 32 of the cabinet at a first cabinet front edge 34, a second water supply line connection 36 at a second top front corner 38 of the cabinet 26 at a second cabinet front edge 40, and a water supply line 42 extending from a water reservoir 44 in the cabinet to the first water supply line connection 30 and to the second water supply line connection 36. The water reservoir 44 may be a container positioned in the refrigeration compartment 28 of the refrigerator 20, or may constitute a length of the water supply line 42 extending through the refrigerator, or other known arrangements for supplying water to dispensers in refrigerators.

As illustrated in the embodiment of FIGS. 1-3, the water supply line 42 may comprise a single line 45 extending from the water reservoir 44 to the first water supply line connection 30 and a jumper line 46 extending from the first water supply line connection to the second water supply line connection 36.

The single line 45 may terminate at a first end 47 in a first cup 48 located in a top surface 50 of the refrigerator cabinet 26 adjacent to the first top front corner 32. The cup 48 provides a recessed space below the top surface 50. The jumper line 46 may terminate at a first end 52 in the first cup 48 and may terminate at a second end 54 in a second cup 56 located in the top surface 50 of the refrigerator cabinet 26 adjacent to the second top front corner 38. In this arrangement, the first end 47 of the single line 45 comprises a first end of the water supply line 42, the second end 54 of the jumper line 46 comprises a second end of the water supply line, and a third end 57 of the water supply line is connected to the reservoir 44.

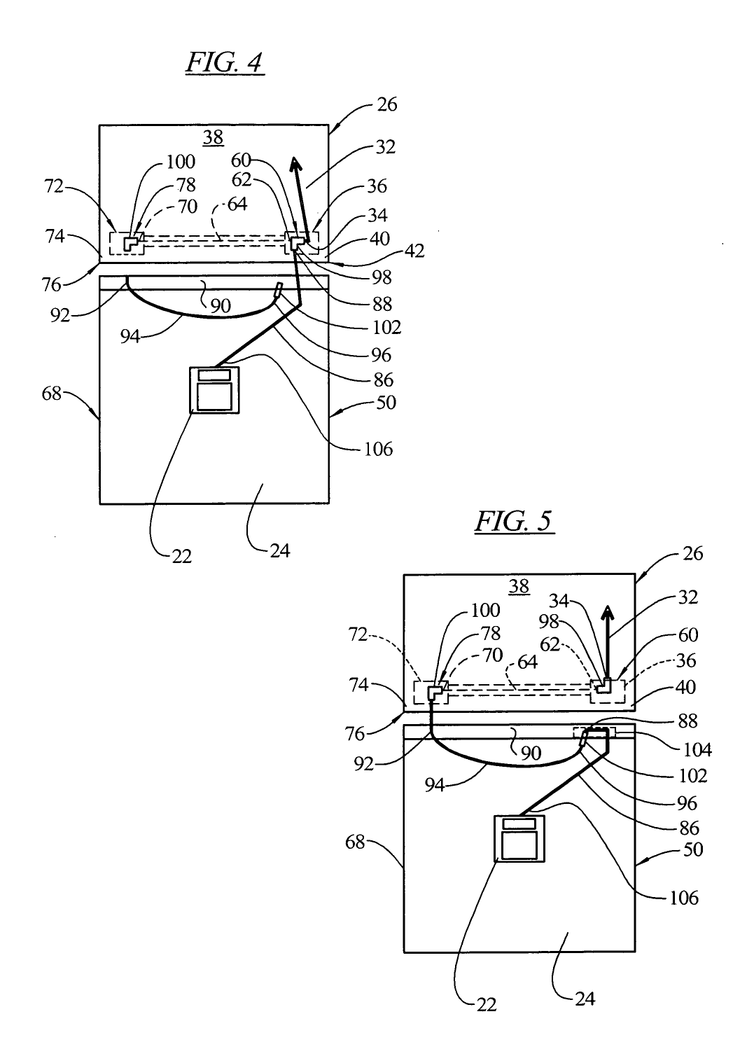

In another embodiment, such as illustrated in FIG. 4, the water supply line 42 comprises a first line 58 extending from the water reservoir 44 to a first end 59 at the first water supply line connection 30 and a second line 60 extending from the water reservoir to a second end 62 at the second water supply line connection 36.

As shown in FIGS. 1-3, the door 24 is arranged to be hinged at a first edge 70 to the cabinet 26 along the first front edge 34 of the cabinet and alternatively at a second edge 72 to the cabinet along the second front edge 40 of the cabinet depending on the desired swing for the door. The water dispenser 22 is mounted on the door 24 and is accessible from an exterior of the cabinet 26. A feeder line 74 leads from the dispenser 22 to a first end 76 at a top surface 78 of the door 24 at the first door edge 70 and to a second end 80 at the top surface of the door at the second door edge 72. When the door 24 is hinged along the first edge 70, the first end 76 of the feeder line 74 is connected to the first end 47, 59 of the water supply line 42 and when the door is hinged along the second edge 72, the second end 80 of the feeder line is connected to the second end 54, 62 of the water supply line.

In an embodiment as shown in FIGS. 1-3, the feeder line 74 leads from the dispenser 22 to the first end 76 at the top surface 78 of the door 24 at the first door edge 78, and a door jumper line 84 is connected at its first end 86 to the first end 76 of the feeder line and extends to the second end 80 at the top surface of the door at the second door edge 72.

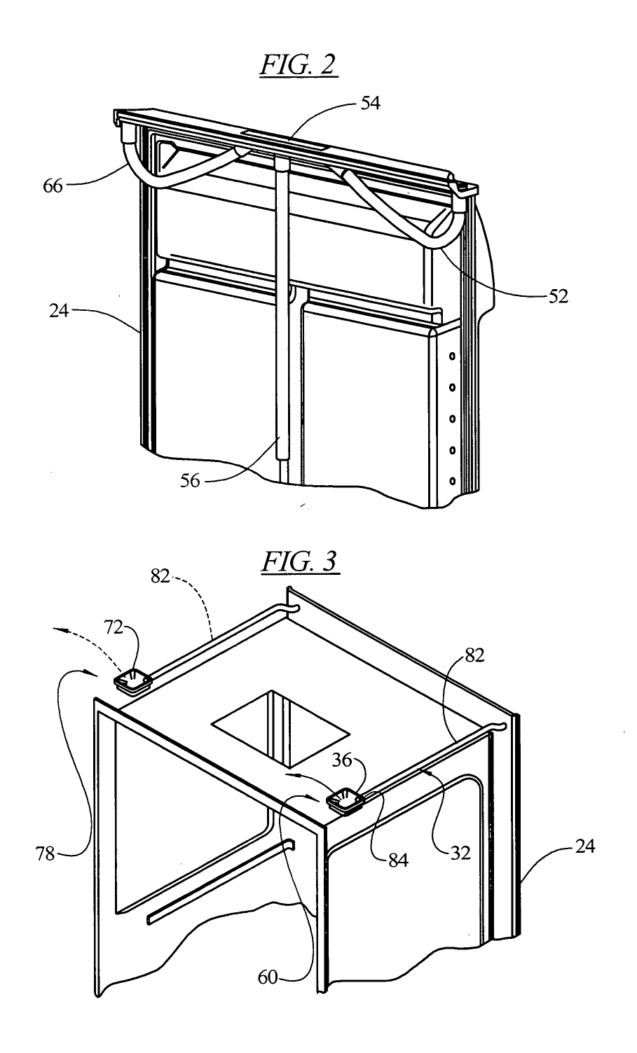

In an embodiment, a first 90, second 92 and third 94 connector are provided. These connectors 90, 92, 94 may be used to connect the various water lines together, as required, and may be of various types providing a water tight seal. A useful type of connector that applicants have located is referred to as a John Guest® connector. When the door 24 is hinged along the first edge 70 (FIG. 2), the first end 76 of the feeder line 74 is connected to the first end 47 of the water supply line 42 with the first connector 90. When the door 24 is hinged along the second edge 72 (FIG. 3), the first end 76 of the feeder line 74 is pulled back into a cup 96 located in the top surface 78 of the refrigerator door 24 adjacent to the first door edge 70. The first end 76 of the feeder line 74 is then connected to the first end 86 of the door jumper line 84 with the third connector 94, the door jumper line second end 80 is then moved to extend through the top surface 78 of the door 24 to enable the door jumper line 84 to be connected to the cabinet jumper line second end 54 with the second connector 92, and the cabinet jumper line 46 first end 52 is connected to the first end 47 of the water supply line 42 with the first connector 90.

In FIGS. 2 and 3, the feeder line 74 has a V shape with one end 99 of the V connected to the dispenser 22. The first end 76 of the feeder line is at the vertex of the V shape and the second end 80 of the feeder line is at an opposite end of the V shape from the dispenser 22.

In each of the arrangements, the water supply line 42 and the feeder line 74, including jumper lines, if utilized in a particular embodiment, may be carried within sheathes, conduits or tubes such that the actual water lines, which may also be formed as tubes, are not in direct contact with the foamed-in-place insulation within the refrigerator cabinet 26 or door 24. In this way, the water lines can be moved or replaced as needed, and are not permanently secured within the refrigerator. Other lines, such as electrical wires, may also be routed through the sheathes, conduits or tubes that carry the water lines, as needed.

In an embodiment as shown in FIG. 5, the feeder line 74 has an inverted L shape and comprises a feed conduit 100 extending through a sheath 101 leading from the water dispenser 22 to a top center 102 of the door 24 where it terminates in a recess or cup 103. A routing conduit 104 leads from the center 102 where it connects to the feed conduit 100, through a first routing sheath 106 to a first end 108 near the first edge 70 of the door 24 when the door is hinged to pivot at the first edge 70. The routing conduit 104 may be connected at a second end 110 to a top end 112 of the feed conduit 100 and the first end 108 is threaded up through a hollow pintle (see FIG. 7) in the door hinge to receive water from the water line 42 and deliver it to the dispenser 22. When the door 24 is hinged to pivot at the second edge 72, the routing conduit 104 is unthreaded from the pintle and is removed from the first routing sheath 106 leading from the top center 102 to the first edge 70, and is inserted into a second routing sheath 114 leading from the top center to near the second edge 72. The routing conduit 104 may be connected at the second end 110 to the top end 112 of the feed conduit 100 so that its first end 108 can be threaded through the hollow pintle of the hinge now positioned on the left side of the refrigerator door 24 to be connected to receive water from the water line 42 and deliver it to the dispenser 22. The top end 112 of the feed conduit 100 may be positioned in the cup or trough 103 located at the top surface 78 of the door 24, easily accessible by removal of a cover 116. The second end 107 of the routing conduit 103 may also be located in the cup or trough. Thus, the user may reverse the swing of the door, and the water routing system via an easy access at the top surface 78 of the door, without having to access the water dispenser 22 or any water connections at the location of the water dispenser.

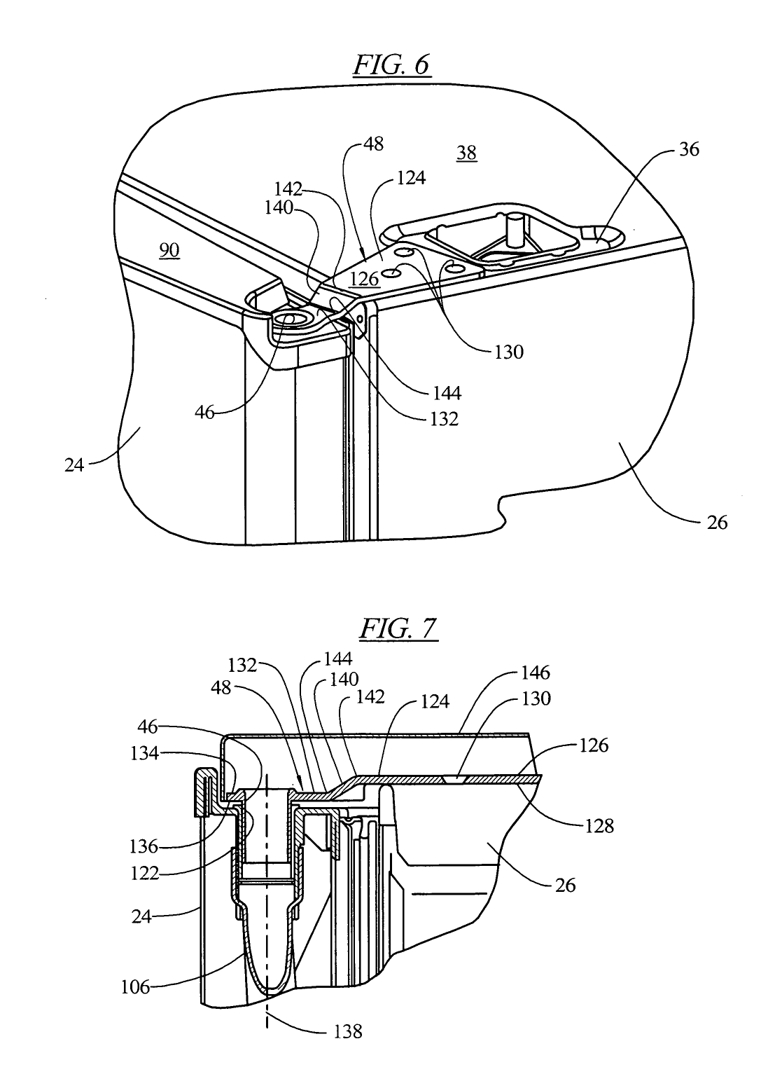

In an embodiment as illustrated in FIGS. 6 and 7, a top hinge 118 for the refrigerator door 24 includes a hollow pintle 120 through which one of the feeder line 74 and door jumper line 84 extend and which is received in a round opening 122 in the top surface 78 of the door. The hinge 118 may comprise a first planar area 124 with an upper surface 126 and a lower surface 128, the first planar area being configured to be received on the top surface 50 of the refrigerator cabinet 26, and secured to the cabinet with threaded fasteners through holes 130 in the first planar area. The hinge 118 also includes a second planar area 132 with an upper surface 134 and a lower surface 136. The second planar area 132 is generally parallel to and positioned at a lower altitude than the first planar area 124. The second planar area 132 carries the pintle 120 extending in a first direction from the lower surface 136 such that an axis of rotation 138 through the pintle will be substantially perpendicular to the top surface 50 of the refrigerator cabinet 26. A transition section 138 connects the first planar area 124 and the second planar area 132. The transition section 138 may be a solid web between the first planar area 124 and the second planar area 132. The transition section 138 may join the first planar area 124 at a first bend 140 in the hinge 118 and the transition section may join the second planar area 132 at a second bend 142 in the hinge. The first 140 and second 142 bends may each be less than 90 degrees.

A hinge cover 144 may be used in connection with the hinge 118, to provide an aesthetic and protective covering for the water lines and electrical wires that may extend through the hinge pintle 120. With the second planar area 132 being at a lower elevation than the first planar area 124, the water line will be permitted to gradually bend and follow a natural radius between the hinge pintle 120 and the cup 48, so that the cover 144 may maintain a low profile, particularly lower than with hinges that are flat or that step up from the cabinet 26 to the door 24.

The present invention has been described utilizing particular embodiments. As will be evident to those skilled in the art, changes and modifications may be made to the disclosed embodiments and yet fall within the scope of the present invention. For example, various components could be utilized separately or independently in some embodiments without using all of the other components in the particular described embodiment. In other embodiments, different combinations of components than those combinations specifically shown and described could be used. The disclosed embodiments are provided only to illustrate aspects of the present invention and not in any way to limit the scope and coverage of the invention. The scope of the invention is therefore to be limited only by the appended claims.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

The embodiments of the invention in which an exclusive property or privilege is claimed are defined as follows:

1. A refrigerator having an in-door water dispenser and a water routing system comprising:
a cabinet enclosing a refrigeration compartment,
a door closing a front opening into said refrigeration compartment, said door arranged to be hinged at a first edge to said cabinet along a first edge of a front of said cabinet and alternatively at a second edge to said cabinet along a second edge of a front of said cabinet,
a water dispenser mounted on said door and being accessible from an exterior of said cabinet,
a water supply line leading from a reservoir in said cabinet to an end adjacent to a first top front corner of said cabinet at said first cabinet edge,
a feeder line leading from said dispenser to an end adjacent a top surface of said door at said first door edge,
a top hinge for said refrigerator door including a hollow pintle through which said feeder line extends,
said hinge comprising a first area configured to be received on a top surface of said refrigerator cabinet, a second area, substantially parallel to and positioned at a lower altitude than said first area, said second area carrying said pintle such that an axis of rotation through said pintle is substantially perpendicular to a surface of said second area, and a transition section connecting said first area and said second area.

2. A refrigerator according to claim 1, wherein said transition section is a solid web extending between said first area and said second area.

3. A refrigerator according to claim 1, wherein said transition section joins said first area at a first bend in said hinge and said transition section joins said second area at a second bend in said hinge.

4. A refrigerator according to claim 3, wherein said first and second bends are each less than 90 degrees.

5. A refrigerator according to claim 1, wherein said first and second areas are substantially planar.

6. A refrigerator having an in-door water dispenser supplied with water through a conduit leading from a reservoir in a cabinet of said refrigerator and a top hinge for a door of said refrigerator, said hinge comprising:
a first area configured to be received on a top surface of said refrigerator cabinet,
a hollow pintle through which said conduit extends,
a second area, substantially parallel to and positioned at a lower altitude than said first area, said second area carrying said pintle such that an axis of rotation through said pintle is substantially perpendicular to said top surface of said refrigerator cabinet, and
a transition section connecting said first planar area and said second planar area.

7. A refrigerator according to claim 6 wherein said transitional section is a solid web extending between said first area and said second area.

8. A refrigerator according to claim 6, wherein said transitional section joins said first area at a first bend in said hinge and said transitional section joins said second area at a second bend in said hinge.

9. A refrigerator according to claim 6, wherein said first and second bends are each less than 90 degrees.

10. A refrigerator according to claim 6, wherein said first and second areas are substantially planar.

11. A top hinge for a refrigerator door, comprising:
a first area having an upper surface and having a lower surface,
a second area, with an upper surface and a lower surface, both surfaces being laterally displaced from said first area lower surface,
a hollow pintle extending in a first direction from said lower surface of said second area,
said upper surface of said second area being displaced in said first direction from said upper surface of said first area, and
a transition section connecting said first area and said second area.

12. A top hinge according to claim 11, wherein said first area is substantially planar.

13. A top hinge according to claim 11, wherein said second area is substantially planar.

14. A top hinge according to claim 11, wherein said upper and lower surfaces of said first and second areas are each substantially parallel to each other.

15. A top hinge according to claim 11, wherein said first area includes fastener openings therein.

16. A refrigerator according to claim 11, wherein said transition section is a solid web extending between said first area and said second area.

17. A refrigerator according to claim 11, wherein said transition section joins said first area at a first bend in said hinge and said transition section joins said second area at a second bend in said hinge.

18. A refrigerator according to claim 17, wherein said first and second bends are each less than 90 degrees.

19. A refrigerator according to claim 11, wherein said pintle extends substantially perpendicularly from said lower surface of said second area.
